(19) United States
(12) Patent Application Publication
(10) Pub. No.: US 2005/0198147 A1
(43) Pub. Date: Sep. 8, 2005

(54) Instant messaging using telephone sets

(76) Inventors: Rodrigo Pastro, Boca Raton, FL (US); Michael E. Kelly, Boca Raton, FL (US); Geert Fieremans, Boca Raton, FL (US); Johannes Ruetschi, Boca Raton, FL (US); Wyatt S. Howe, Boca Raton, FL (US); Roger Urscheler, Boca Raton, FL (US); Joseph LoBuono, Delray Beach, FL (US); Ming Chao, Sammamish, WA (US)

Correspondence Address: Siemens Corporation;Intellectual Property Department, 170 Wood Avenue South, Iselin, NJ, 08830, US

(21) Appl. No.: 10/761,059

(22) Filed: Jan. 20, 2004

(51) Int. Cl. G06F 15/16; H04M 11/00

(52) U.S. Cl. 709/206; 379/93.24

(57) ABSTRACT

A method and an apparatus for providing Instant Messaging (IM) capability in digital telephone sets is disclosed. The invention allows telephone users to compose and display Instant Messages and to exchange contact lists with other telephone users or users of an Internet-based messaging system. The method of the invention in one embodiment allows digital telephones, with limited keys and display space, to support the full functionality of Instant Messaging. Quick compose and quick reply mechanisms allow sending common messages with minimum keypad button pushes. The invention also allows Computer Supported Telephony Application (CSTA) based messages to interface with the Session Initiation Protocol (SIP) messages, thus permitting IM exchanges between digital telephone set users and Window Messenger clients.

### FIELD OF THE INVENTION

The present invention relates generally to communication systems, and specifically, to a method for providing Instant Messaging (IM) capability to digital display telephone devices, and more specifically, to a system for providing instant messaging between digital display telephones and an Internet-based messaging system using Computer Supported Telephony Application (CSTA) as an intermediate layer.

### BACKGROUND OF THE INVENTION

Instant messaging (IM) software is a distributed communication tool that allows users to communicate through peer-to-peer service using a communication server. Currently personal computer (PC) users running the Window Messenger (WM) application can send and receive IM messages. With IM, the PC users can easily see whether a chosen friend or co-worker is connected, and if they are, to exchange messages with those users. IM is a popular way of communication that is immediate, interactive and, unlike a telephone call, allows the user to decide whether and when to participate in the communication. The IM capability for PCs is facilitated by the “SIP/SIMPLE” protocol, which allows IM commands to be relayed from one WM user to an IP Network based server, and later to another WM user. The SIP/SIMPLE protocol is a Session Initiation Protocol that is defined by the Internet Engineering Task Force (IETF) and used to provide call control software for interactive user sessions. The SIMPLE protocol is an extension of SIP that specifies the IM aspect of the interface.

In known telephone systems, Computer Supported Telephony Application (CSTA) has been used to enhance Private Branch Exchange (PBX) functionality. The CSTA utilizes the power and flexibility of computers to enhance features and capabilities provided by standard telephone systems. For instance, using CSTA, the voice mail system (which is a separate entity that records and replays voice messages) can interact with the PBX to allow telephone users to record, leave and retrieve voice messages from the voice mail system. The CSTA is a standard interface for Computer Telephony Integration (CTI) that is vendor and media independent. The CSTA agent is typically a software application that monitors and mediates the communications between a CSTA-compliant application (e.g. telephone) and the actual call handling mechanism of an Internet Protocol (IP) enabled PBX. In particular, the CSTA agent monitors the call handling actions of the PBX and sends state changes as events to the CSTA application.

However, in spite of the aforementioned applications of CSTA there is currently no capability for providing IM to telephone users. Thus, users of traditional display telephones (such as found on a modern PBX) do not have IM capability at the present time. There is no current mechanism for providing IM with convenient operation between telephone users, or between telephone users on one hand and PC users on the other hand.

Currently, telephone user communications are limited to traditional voice calls and voicemail. While some PBX systems may provide the rudimentary ability to send pre-defined one-way broadcast messages to all associated digital telephones, the receiving telephone sets have no way of identifying the sending entity nor the ability to compose and send messages to other telephone set users or PC users.

### SUMMARY AND OBJECTS OF THE INVENTION

The foregoing and other problems and deficiencies in the prior art will be addressed by this invention, which provides IM using traditional telephone sets and allows, e.g., IM between those telephone set users and PC users or IM between users of telephone sets. The present invention is a systems for providing IM between digital display telephones (also referred to in this application as digital telephones, telephone sets or telephone clients) and an Internet-based messaging system, using CSTA as an intermediate layer. The present invention extends the IM solution to digital telephone sets with digital display and a dedicated and/or configurable key, allowing communications with other digital telephones, cell phones, PC and Personal Digital Assistant (PDA) users. The invention will allow these telephones to send and receive IM messages to and from other IM compatible units without needing to be off-hook. Throughout this document the term “PC user” or “PDA user” implies that an IM client is installed and available on the PC or PDA.

The invention provides, in one part, for communicating between the SIP/SIMPLE protocol on the one hand, and the CSTA protocol on the other, using an Interworking Unit (IWU) as a protocol converter. Under the present invention, the CSTA I/O services are used to establish a direct connection between a telephone set and the CSTA such that the application receives information for all the keys pressed at the telephone set and it has full control of the display on that telephone set.

Furthermore, the invention defines a process by which a digital telephone set, with limited keys and display space, can support the full functionality of IM including, e.g., composing messages, responding to messages and creating a buddy list.

One aspect of the present invention is that it allows the CSTA to be used as an interworking mechanism between IM clients to send and receive IM at digital telephone sets.

It is an object of the invention to provide a method and apparatus for providing interworking between standard PBX telephone sets and PC-based IM clients.

It is another object of this invention to provide the ability to receive and display IM messages on digital telephone sets.

It is also an object of this invention to support the full functionality of IM between a CSTA compatible digital telephone set and a PC or PDA running a WM application.

It is yet another object of this invention to support the full functionality of IM between two or more CSTA compatible digital telephone sets.

It is another object of the invention to provide methods for querying the status of a buddy-list member from the telephone.

It is yet another object of the invention to provide methods for reporting user presence status based on telephone activity (idle, on-the-phone, etc).

Still further, it is an object of the invention to provide a complete IM functionality on telephone sets with limited buttons and small display.

It is also an object of this invention to provide a quick compose and/or quick reply mechanism for sending common messages with minimum keypad button pushes.

It is also an object of this invention to provide a quick compose and/or quick reply mechanism for sending common messages having custom data with minimum keypad button pushes.

### BRIEF DESCRIPTION OF THE DRAWINGS

The foregoing and other features and advantages of the present invention will become more apparent in light of the following detailed description of exemplary embodiments thereof, as illustrated in the accompanying drawings, where:

FIG. 1 is a schematic block diagram of the implementation of the present invention in an illustrative embodiment.

FIG. 2 is a schematic block diagram showing an exemplary embodiment of connectivity between a CTI protocol based system and SIP/SIMPLE protocol based system.

FIG. 3 is a flow diagram of a user-initiated sign-in procedure in a preferred embodiment for a telephone set client.

FIG. 4 is a flow diagram of a procedure in a preferred embodiment for adding a telephone set client to the contact list of another user.

FIG. 5 is a flow diagram of the steps involved in a preferred embodiment for sending an IM to a telephone set client.

FIG. 6 is a flow diagram of dynamic status update procedure in a preferred embodiment for a telephone set client.

FIG. 7A-C illustrates exemplary telephone set display menus in a preferred embodiment.

### DETAILED DESCRIPTION

Under the present invention, IM services are extended to digital telephone sets. In an illustrative embodiment, this is accomplished by connecting a Computer Telephony Integration (CTI) based telephonic switch, for example PBX, to a SIP Proxy server and by converting between the CSTA and SIP/SIMPLE protocols using the IWU described herein.

Telephone set communications within the CTI platform are based on the use of the CSTA I/O Services. The I/O services are used to establish a direct connection between a telephone set and a CSTA application implemented as part of the CTI platform. Such application monitors the telephone set activity and key usage, receives information for any keys pressed at the telephone set and has full control of the telephone set display.

For PC users capable of IM, e.g. those who are WM clients, communications are based on the SIP/SIMPLE protocol. The Interworking Unit (IWU) is used to link the two otherwise incompatible communication protocols, SIP and CSTA, inter alia, thus supporting presence and status information for digital telephone sets and PC users and enabling the IM capability between the different protocol devices.

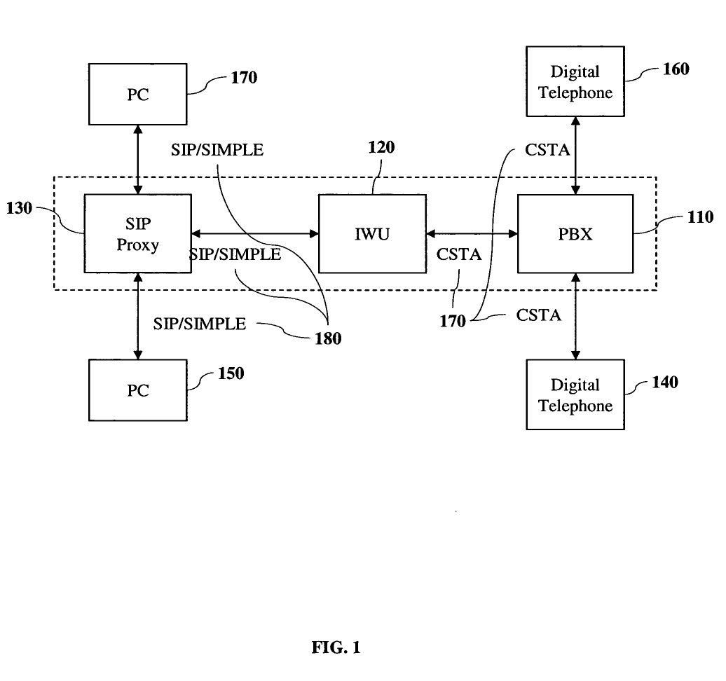

FIG. 1 shows a block diagram of the functional elements of the present invention in an illustrative embodiment. One or more digital telephone clients, e.g. 140 and 160 connect to a PBX 110 using the CSTA protocol 170. Furthermore, the PBX 110 is connected to an IWU 120 using the CSTA protocol 170. Any PC clients, e.g. 150 and 170 connect to a SIP Proxy server 130 using the SIP/SIMPLE protocol 180. Additionally, the IWU 120 is connected to the SIP Proxy server 130 using the SIP/SIMPLE protocol 180. As will be discussed in further detail below, under the present invention, IM can be carried out between a connected PC and a connected telephone client or between two connected telephone clients.

The PBX 110, IWU 120 and SIP Proxy server 130 may be integrated as a single entity. Alternatively, the IWU 120 may be part of the PBX 110 or may be integrated with the SIP Proxy server 130. Furthermore, one or more PBXs, or one or more SIP Proxy servers may be connected to a single IWU. Thus, location of the IWU is not critical other than that both the PBX and SIP Proxy server interface with the IWU.

In the illustrative embodiment, the PBX 110 is a CSTA capable telephonic switch, e.g. PBX. It may be an IP based PBX, or any other PBX that supports CSTA. PBX 110 may be located at a central office or on a customer premise. The IWU 120 is a device that serves several functions in the present invention, including that as protocol converter unit that converts CSTA 170 to SIP/SIMPLE 180. It also hosts the application for managing IM on the digital telephone sets 140 and 160. IM management for digital telephones includes for example, allowing the telephone user to compose, retrieve and respond to a message. It also involves controlling the menu display on the telephone.

The SIP Proxy 130 can be implemented as a server that stores IM device information (the IP address of the client PC, PDA or digital telephone, etc.) for registered IM users, and maps users to specific devices. Since the IM messages usually specify a client identity (i.e. the user) and not a specific device identity, the SIP Proxy server is used to determine the recipient destination prior to delivering the message. Thus, connection to the SIP Proxy server 130 is established even when no PCs are participating in the IM session.

In the preferred embodiment of the present invention, establishing an IM session between PC 150 and PC 170 does not require the IWU 120 or the PBX 110. If one or more digital telephone clients participate in the IM session, the IWU 120 and PBX 110 will be required to implement functionality of the present invention.

In order for digital telephone 140 to exchange an instant message with another client, whether that client is another telephone 160 or PC 150, the message originating from digital telephone client 140 is communicated to the PBX 110 and then to the IWU 120 using the CSTA protocol 170. At the IWU 120, the CSTA protocol is converted to a SIP/SIMPLE protocol 180, and the message is forwarded to the SIP Proxy server 130. At the SIP Proxy server 130, the recipient information (e.g. user identity) is read and consequently mapped to a specific device, and the message is routed to that device via the appropriate intermediate destination or destinations. According to the exemplary illustration of FIG. 1, if the recipient is the PC client 150 or 170, the SIP Proxy server 130 sends the IM to the intended client directly. If the recipient is telephone client 160, the SIP Proxy server 130 sends the message back to the corresponding IWU 120, where the IM application for the digital telephone is managed, the IM message is reconverted to CSTA and sent to PBX 110 and then to digital telephone 160 using CSTA 170.

In the preferred embodiment of the present invention, the SIP/SIMPLE protocol is responsible for managing and determining the presence information of the IM user. It is also responsible for managing the phone display and IM menus. The CSTA is the transport mechanism that allows these messages and IM commands to be communicated within the PBX.

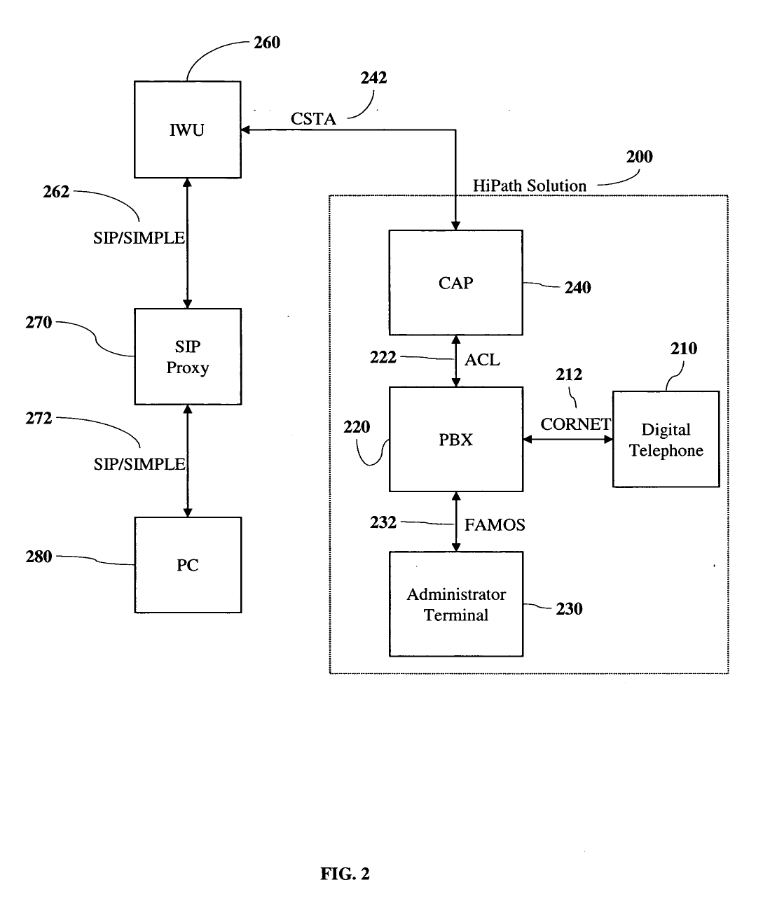

FIG. 2 shows a block diagram of the system architecture of one specific embodiment of the present invention. As will be discussed in detail below, the architectural elements of the system in the illustrated embodiment include Siemens HiPath Solution 200 comprising a digital telephone set 210, an IP based PBX 220, an administrator terminal 230 and a Common Application Platform (CAP) 240. The HiPath Solution 200 interfaces with the IWU 260 using the CSTA protocol 242, which in turn interfaces with Personal Computer (PC) 280 through the SIP Proxy 270 using the SIP/SIMPLE protocol 262 and 272.

The communications between the digital telephone 210 and the PBX 220 is accomplished via the CORNET protocol 212. Furthermore, the ACL protocol 222 is used to communicate between CAP 240 and the PBX 220. The administrator can communicate with the PBX 220 using the Administrator Terminal 230 via the FAMOS protocol 232. In this illustrative embodiment, protocols 212, 222 and 232 may be the signaling interfaces CORNET, FAMOS and ACL, respectively. Alternatively, other proprietary or standard interfaces based on or compatible to the employed PBX may be utilized. As shown in FIG. 2, all communications interfaces 212, 222, 232, 242, 262 and 272 are bi-directional.

The HiPath Solution 200 is a single logical block that represents an architectural view of the IP enabled PBX that is capable of communicating via a CSTA link. The HiPath Solution 200 shown in FIG. 2 is an illustrative example of a PBX architecture representing the required functional elements to support the CSTA protocol. It is to be understood by those implementing this invention that if a single CSTA enabled PBX is used, the CAP 240 and interfaces 212, 222 and 232 might not be required.

The Digital Telephone 210 is a telephone set with a digital display and at least one, and preferably more than one, programmable keys. One or more of the programmed keys will be configured as dedicated IM keys, and will be controllable via CSTA. The digital telephone 210 may be, for example, an IP telephone, an ISDN telephone or a TDM telephone. The CAP 240 in FIG. 2 hosts the CSTA application and provides the CSTA interface to the PBX 220. The Administrative terminal 230 provides the means for the administrator to access the PBX 220 database and the CSTA application.

The IWU 260 interfaces with CAP 240 using the CSTA link 242. A software program resides at the IWU 260 to extend the IM capability to telephone sets 210 by mapping the SIP protocol messages and the CSTA encoded messages. While the IWU 260 is shown as a separate block outside the HiPath Systems 200 logical block, in other embodiments it may be collocated with the CAP application server 240.

The IWU 260 communicates in this illustrative embodiment with PC 280 via the SIP/SIMPLE Proxy 270. The PC 280 in FIG. 2 represents a standard PC running an IM application such as WM. However the device 280 could be any device capable of running WM, such as a Personal Digital Assistance (PDA) or the like.

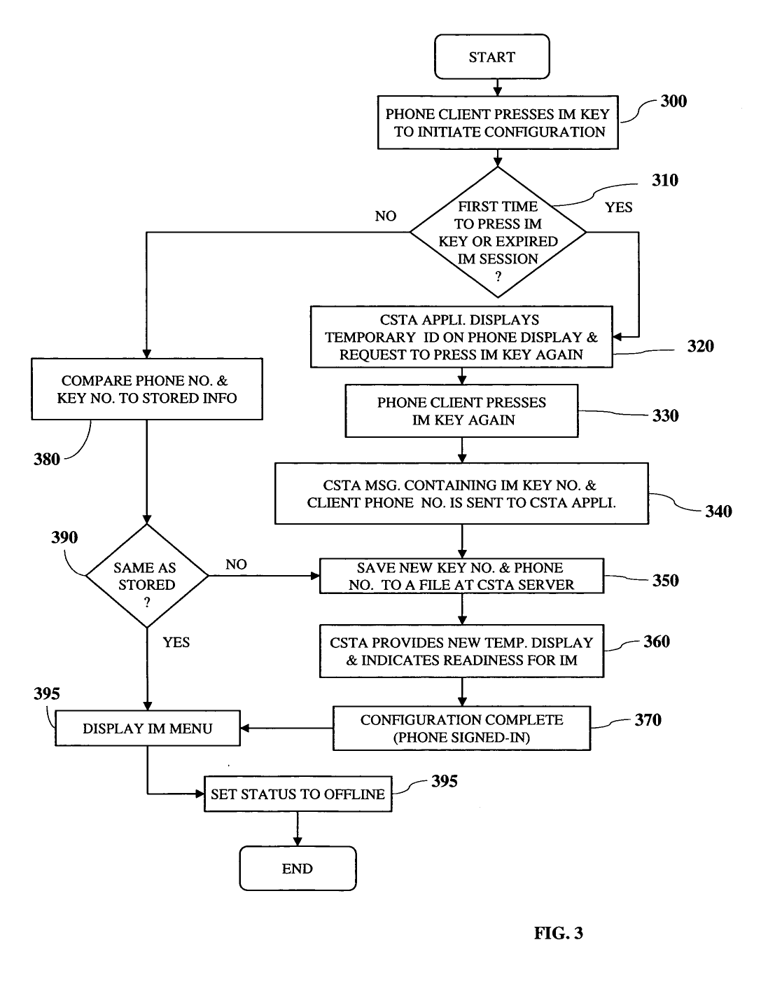

FIG. 3 describes the flow diagram of a telephone client (digital telephone set user) initiated sign-in procedure in the illustrative embodiment of the invention. The telephone client needs to “sign-in” in order to access the CSTA application and start an I/O session with the application (in this specification the definitions “sign-in”, “sign-out”, “online” and “offline” are consistent with the commonly used Windows Messenger definitions of these terms). By accessing the CSTA application, the telephone client may navigate the appropriate menus on the digital display of the telephone set to sign-out, select desired status (on-line or off-line) or choose other IM options, as will become apparent later. A signed-in user will have the ability to view the status of other IM or telephone users.

The sign-in procedure involves an administrator executed step and a telephone client executed step. In order to initiate the sign-in procedure the HiPath administrator needs to configure the dedicated telephone key at the PBX and to configure the key number and telephone number of telephone client at the CSTA application. This step is necessary in order for the CSTA Application to control the LED for the Instant Messaging key at the telephone client. The administrative sign-in procedure involves configuring the digital telephone dedicated key as a NAME key (DDS key) containing the Non-Voice access code and the CSTA application number. This key will be referred to as the IM key in this specification. The configured IM key will be used later to start the I/O session with the CSTA application. This step is performed only once. Next, the telephone user configures the telephone number and the IM key number at the CSTA application.

After the administrator performs the sign-in procedure described above, the telephone client initiates the procedure by pressing the IM key at 300. Since the IM key was previously configured at the PBX, the key is recognized as a special key and a decision is made at 310 by the CSTA application based on prior usage of the IM key. That is, if the CSTA application at 310 determines that this is the first time the IM is used within an administrator defined IM activity time period (for example 4 hours), it recognizes that the IM key and the client telephone number need to be programmed at the CSTA application, and it performs this step and prompts the telephone client to press the IM key again at 320. By pressing the IM key again at 330, the client causes the telephone set to send a message containing the IM key number and client telephone number to the CSTA application at 340. The received key number and telephone number are saved to a file at the CSTA server at step 350. Consequently, the CSTA application sends and displays a message to the telephone client indicating readiness to support IM at step 360. At 370, the telephone client configuration is complete and the telephone client is signed-in. The CSTA application displays the IM menu at the client telephone at 395 and sets the telephone client status to offline at 396 and the telephone LED to off.

In the event of a moved telephone set or a deleted IM key, the CSTA application tracks the IM key activity over time. If a telephone's IM key is not pressed within the specified activity time period, the CSTA Application automatically deletes the telephone from its database.

If the telephone client presses the IM key within the administrator specified IM activity period, at 380 the CSTA application recognizes the telephone set and compares the telephone number and key number received in the CSTA message with the previously stored information. A decision is made at 390 based on the contents of the message. If the received information is the same as the stored information at 350, the telephone client starts the IM session and accesses the IM menu at 395. This causes the status of the telephone client to be set to offline at 396. If the new data differs from the stored data, the new data replaces the stored data at 350, and steps 360 and 370 in FIG. 3 are followed. Subsequently, the IM menu is displayed at 395 and the client status is set to offline at 396. As indicated above, when the telephone client signs-in, it gains access to the CSTA application. Furthermore, the sign-in procedure causes the client information current device information to be saved at the SIP Proxy server. This information is later used to map the IM recipient name to the appropriate device (digital telephone, PC, etc.).

In the illustrative embodiment, at the completion of the sign-in procedure the telephone client status is set to off-line as a default state. While off-line, the telephone client will not be able to send or receive IM. This options provides users with the flexibility to determine when it is desirable to exchange IM messages. The telephone client can choose to go on-line by pressing the IM key, navigating through the status key and choosing the on-line option.

In this illustrative embodiment, the sign-in procedure has no impact on the phone set availability and no special action is required from the user if an IM key is added to a new telephone, deleted from a telephone or moved to a different key number.

The sign-in procedure illustrated in FIG. 3 represents one of several methods to configure the IM key and the CSTA client telephone number at the CSTA application. For example, alternatively the sign-in procedure can be performed manually by the administrator. In such manual configuration embodiment, reconfiguration is required whenever a change in the telephone set/PBX system (e.g. HiPath 4000) configuration occurs (e.g., IM key is added to a new telephone, deleted from a telephone or moved to a different key number).

The process of adding an IM client to a contact list is now explained further with reference to FIG. 2. When a PC user 280 running a WM application requests to add a signed-in telephone client 210 to its contact list, the request starts at the WM application, passing via the SIP Proxy 270 and the IWU 260. The SIP/SIMPLE message transmitted over interfaces 272 and 262 is converted at the IWU 260 to a CSTA message that is transmitted over the CSTA interface 242 and relayed to the CSTA application at CAP 240. Subsequently, the CSTA application sends the CSTA message to the digital telephone set via the PBX 220 and interface 212, causing the LED to blink and the digital display for the telephone set 210 to indicate a request to be added to the contact list of another IM client 280.

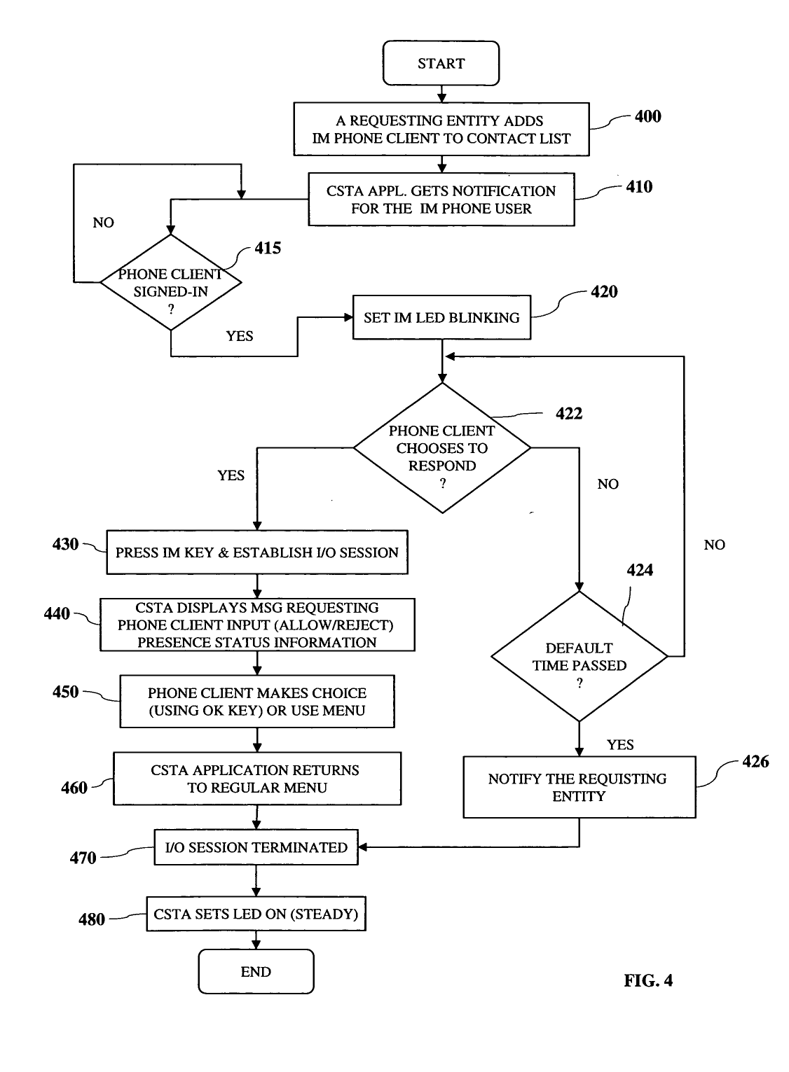

FIG. 4 is one illustrative embodiment of a process for adding a telephone client to a contact list. In order to communicate with selected peers, the IM users need to create and maintain a contact list (buddy-list). Each user (PC user, PDA user or digital telephone user) can request to add another signed-in IM user to its contact list. The request will be directed from the requesting entity to the requested entity asking that permission be granted. The response from the requested client is relayed back to the requesting client and the contact lists are updated accordingly. If the request is granted, the contact list of both users will be amended to include the other entity and the updated file is saved at the IWU. The stored contact lists remain static, and will be maintained as long as the user is signed-in at the CSTA application. Furthermore, the user may edit the list at a later time.

An on-line WM client or a digital telephone client starts the process of adding other clients to its contact list by browsing through the menus to see the list of on-line users. Specifically, at 400, the requester sees a telephone client signed-in and sends a request to the telephone client to be added to its contact list. The CSTA application for the requested telephone client receives the notification at 410. If the telephone is not signed-in, the application waits for the client to sign-in 415. If the telephone client is signed-in, the CSTA application sets the LED for the requested client to blink at 420. A decision is made at 422 based on the telephone client response. If the telephone client chooses to respond by pressing the IM key and establishing an I/O session at 430, the CSTA receives a message for the telephone client, displays the name of the requesting entity at 440, and awaits the telephone client response. Consequently, the telephone client makes a choice (using the OK key or other menu options) at 450. The response is relayed back to the requesting entity via the CSTA message. The telephone client may choose to return to the application menu at 460, thus terminating the I/O session at 470. When the I/O session is terminated, the CSTA sets the LED to on (steady) at 480. If the telephone client does not respond to the request within an administrator specified time period at 424, the CSTA notifies the requesting entity at 426 that the telephone client did not respond and terminates the I/O session at 470.

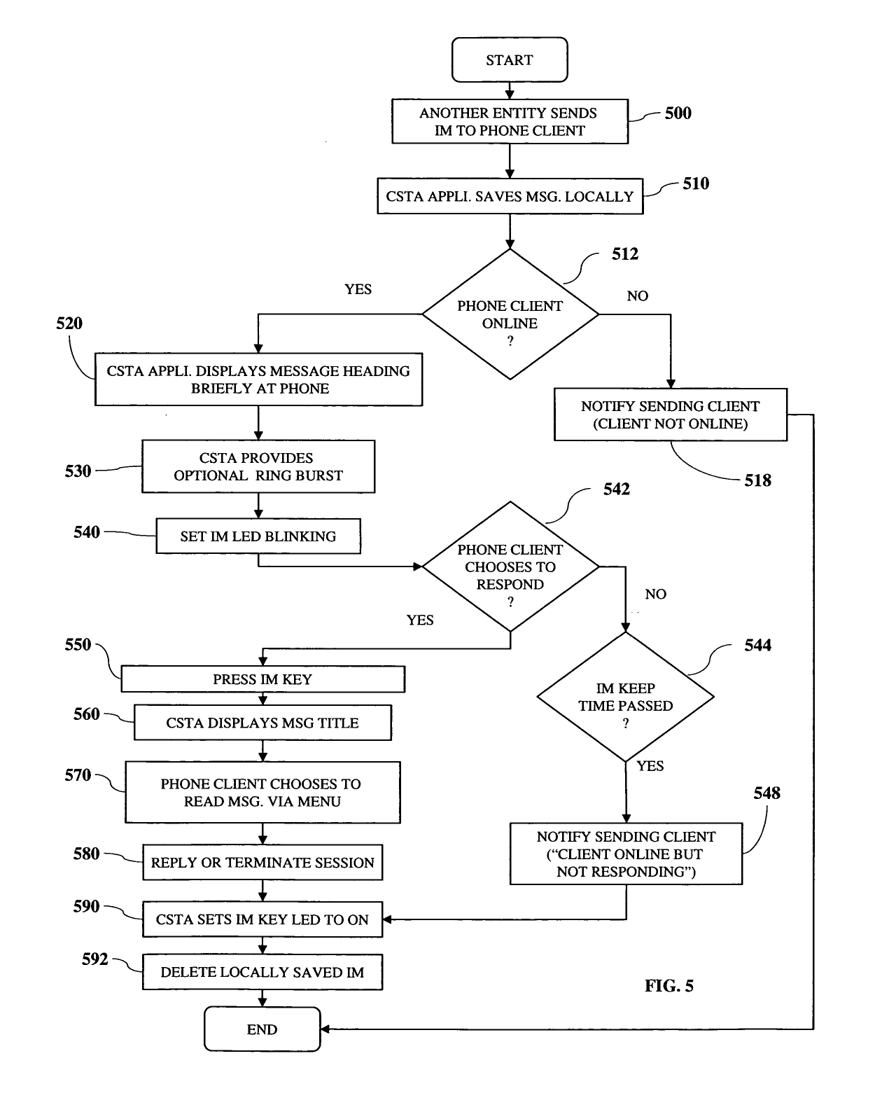

FIG. 5 is an illustrative embodiment of the steps involved when an IM client sends an IM message to a telephone client on its contact list in one embodiment of the invention. A telephone client that is on-line can communicate with other peers who are part of the contact list using IM without going off-hook. Under the system of the present invention the telephone client has the ability to send and receive IM from other telephone clients or WM. The process starts when a member of the telephone client contact list (e.g. another telephone client or WM client) sends an IM to a signed-in telephone client at 500. When the message is received by the CSTA application, it saves it locally at 510. At 512, if the telephone client is not on-line, the CSTA notifies the sending client at 518 and terminates the I/O session. If the telephone client is on-line, the CSTA application displays the message heading for a limited time (e.g. on the order of a few seconds) on the telephone set display at 520. Furthermore, in the illustrative embodiment, the CSTA application accompanies the brief message display with an optional ring burst at 530 and causes the telephone client LED to start blinking at 540.

At 542, the CSTA responds based on the telephone user choice. If the phone client presses the IM key at 550 to display the message, the CSTA application displays the message title on the phone set display at 560. Furthermore, the phone client may utilize the digital phone menu to scroll through the message at 570. In digital phones equipped with “+”, “−” or “>” and “<” keys, these keys may be used to scroll through the message. Otherwise, alternative keys may be programmed to provide these functions. In one embodiment, if the message contains more characters than the phone display can accommodate, the message text will be wrapped around and the last two characters in the display are used to indicate the ability to scroll.

The display options also allow the phone client to reply to the message or terminate the I/O session at 580. The reply may be in the form of a predefined menu response, such as “ok”, “yes”, “no”, etc. At the end of the I/O session, the CSTA sets the phone client LED to on (steady) at 590, and deletes the previously saved IM message at 592.

If the phone client does not respond to the received IM message at 542, the CSTA continues to monitor the phone client activity until the timer expires. When the administrator specified timer expires at 544, the CSTA application notifies the sender with a message, e.g. “Client online but not responding”, or another message at 548.

Under the present invention, a similar procedure may be used to support a phone client initiated IM message to another phone client or PC user, as will be understood by those skilled in the art. In an alternative embodiment of the present invention, the phone client may use protocols such as T9 or other alphanumeric keypad to compose a message.

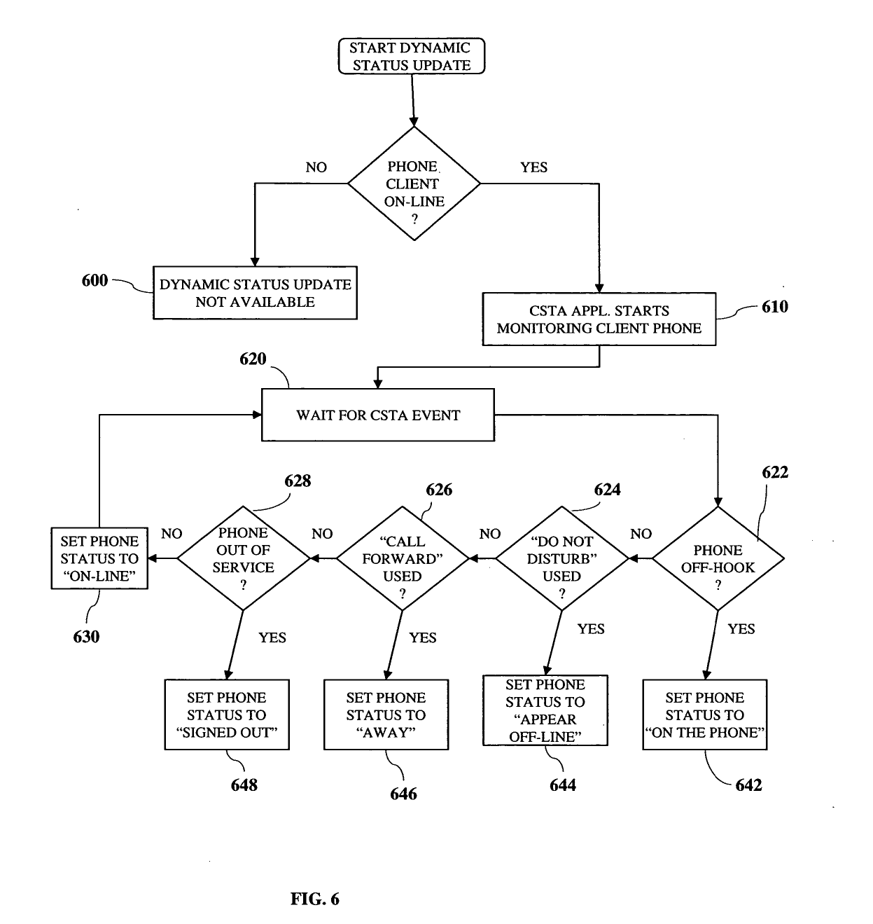

FIG. 6 describes one illustrative embodiment for implementing the dynamic status update for a phone user. Since the phone client status is important in determining availability for receiving IM messages, the present invention provides a simple and flexible method for signing-in, signing-out and for changing the on-line/off-line status for a phone client. Furthermore, in the illustrative embodiment, the invention provides a method for updating the IM status of an on-line phone client dynamically based on the phone set usage and status.

The invention presents a method for the phone client to switch the on-line/off-line status based on pressing the IM key. By pressing the IM key, the CSTA application alternates the phone client status between on-line and off-line and sets the LED to on or off, respectively.

The CTI platform allows telephony events to trigger CSTA events that will prompt the application to communicate the required action to the IWU and to the CSTA enabled telephone set. As shown in FIG. 6 at 600, the dynamic status update is not available for phone clients who are off-line. For phone clients who are on-line, the CSTA application continuously monitors the phone activity at 610. As a result of detecting a CSTA event at 620, the CSTA application determines the appropriate status display based on the type of telephone activity taking place. For example, if the phone is off-hook at 622, the digital phone sends a message to the CSTA application, which in turn sets the phone status to “On the Phone”, as shown at 642. Other telephony actions such as invoking the “Do Not Disturb” key at 624 or “Call Forward” key at 626 will be interpreted by the CSTA application as “Appear Off-line” at 644 or “Away” at 646, respectively. If the telephone set is taken out of service at 628, the dynamic status will be set to “Appear Off-line” or “Signed-out”, or other similar status indicators at 648. When the phone client dynamic status is set to be “off-line” or an equivalent to off-line, the LED will be set to off. If the phone client does not perform any telephony action that alters the on-line status, the phone IM status remains unchanged at 630 and the CSTA continues to monitor the phone set activity at 620.

It is to be understood that the LED status is not limited to on, off and blinking. It is also possible within the scope of the invention e.g. to map a phone client status to wink (i.e. blink at a different frequency than blink).

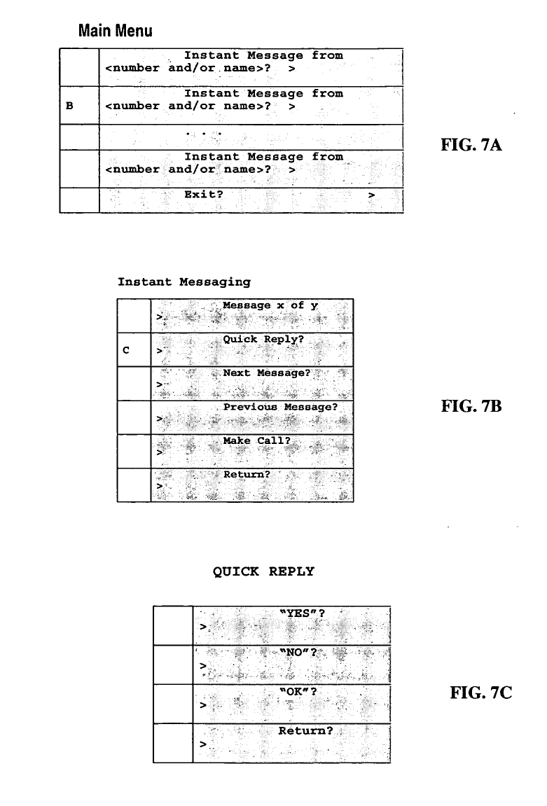

This invention is facilitated by the use of menu options that are accessible from the digital display of the phone set. FIG. 7A shows one illustrative embodiment of the invention in which a menu listing the heading of all available IM options is displayed upon pressing the IM key. The full menu in FIG. 7A is accessible using the “>”, “<”, “+” and “−” key, or other similar keys. When the user chooses to display one of the available IM option (“B”) in FIG. 7A, a menu similar to that shown in FIG. 7B is displayed. The menu in FIG. 7B allows the phone client to display the message, reply, move to the next or previous message, make a call, or return to the message list menu.

In FIG. 7C, an exemplary quick reply menu selected from IM menu FIG. 7B is shown. The menu includes common reply messages such as “YES”, “NO” or “OK”. These options allow the phone user to use commonly used responses to reply to a received IM message quickly and without the need to compose the message.

Examples of embodiments of quick compose and quick reply may include the option of selecting a word or phrase with custom data. For either quick compose or quick reply, a predefined menu of possible words or phrases can be set by a system administrator. In a preferred embodiment, a user may create a customized predefined menu.

In a preferred embodiment, at least one word or phrase has a custom data field for entering custom data. For example, a predefined menu of quick compose words and phrases may include the following: “Come to my office”, “Lunch?”, “Please call me”, “I'm leaving now”, “Call me at xxx-xxxx”, and “Meet me in x minutes”. If the user selects one of the last two options, the user is prompted to enter custom data. For example, if the user chooses the last option, there is a prompt to enter a number or numeric string for x. As another example, a predefined menu of quick reply words and phrases may include the following: “Yes/OK”, “No”, “Call me”, “Call me later”, “I'll be right there”, “Give me x minutes”, “Call me at xxx-xxxx”, and “I'll call you in x minutes”. If the user selects one of the last three options, the user is prompted to enter custom data. In a preferred embodiment, the predefined menu of quick reply words and phrases depends on the message to which the user is replying.

The following is a usage example of quick compose and quick reply. Using a phone set IM menu, user A selects the option to send an IM to user B. User A, rather than composing the IM one letter at a time, accesses the quick compose list instead of selecting the compose option. The system shows the first quick compose option. At this point, user A may choose from a menu or list of words or phrases (which might not fit on one screen). User A scrolls through the list and selects “Come to my office”. When selected, the system sends an IM from user A to user B, with the message “Come to my office”. User B receives the IM and uses a telephone set display to read the IM. The display options also allow the phone client to reply to the message. User B selects the “Reply?” option and then is prompted to compose a reply but decides to skip the “Compose?” option and sees the first of the quick reply options. User B scrolls through the list or menu of quick reply options until “Give me x minutes” is seen on the display. User B selects this reply and the system prompts user B to “Enter custom data”. User B enters the numeric data “15”, and the system sends an IM to user A with the message “Give me 15 minutes”.

The embodiments in FIG. 7A-C are only examples. It is to be understood that the CSTA application can accommodate the design of any customized menu or no menus. In another embodiment, on-line and off-line menus could be supported such that only relevant actions are displayed. In a further alternate embodiment, for example the main menu can include other options to view and modify the status, view and modify contact list and view the presence and status of other IM users.

While the invention has been described in terms of preferred embodiments, those skilled in the art will recognize that the invention can be practiced with modification without departing from the spirit and scope of the invention. It is therefore intended that the present invention is not limited to the disclosed embodiments described herein but should be defined in accordance with the claims that follow.

1. An apparatus for performing instant messaging (IM) under a first protocol, said apparatus comprising:
a first device;
a second device implementing a second protocol;
a protocol converter to convert between said first protocol and said second protocol;
a register to register said first device and said second device; and
a map to map a first client to said first device and a second client to said second device.

2. The apparatus of claim 1 wherein said first protocol is a Session Initiation Protocol (SIP).

3. The apparatus of claim 2 wherein said second protocol is a Computer Supported Telephony Application (CSTA).

4. The apparatus of claim 3 wherein said first device is a first protocol device.

5. The apparatus of claim 4 wherein said first device is a Personal Computer (PC).

6. The apparatus of claim 4 wherein said first device is a Personal Digital Assistant (PDA).

7. The apparatus of claim 3 wherein said second device is a digital telephone.

8. The apparatus of claim 7 wherein said digital telephone is connected through a telephonic switch.

9. The apparatus of claim 8 wherein said telephonic switch is a Private Branch Exchange (PBX).

10. The apparatus of claim 3 wherein said first device is a second protocol device.

11. The apparatus of claim 10 wherein said first device a digital telephone.

12. The apparatus of claim 11 wherein said digital telephone is connected through a telephonic switch.

13. The apparatus of claim 12 wherein said telephonic switch is a Private Branch Exchange (PBX).

14. A method for supporting Instant Messaging (IM) in digital telephones, comprising the steps of:
registering a first protocol digital telephone set;
converting said first protocol to a second protocol;
mapping a client to said digital telephone set; and
communicating an instant message to or from said digital telephone set.

15. The method of claim 14 furthering comprising the steps of:
registering a second device; wherein said mapping step further maps a second client to said second device and said communicating step further includes communicating an instant message between said first digital telephone set and said 25 second device.

16. The method of claim 15 wherein said second device is a personal computer (PC); and wherein said mapping step further maps a second client to said PC and said communicating step further includes communicating an instant message between said first digital telephone set and said PC.

17. The method of claim 15 wherein said second device is a first protocol digital telephone set; and wherein said converting step also converts said first protocol device to said second protocol device, said mapping step further maps a second client to said second digital telephone set and said communicating step further includes communicating an instant message between said first and said second digital telephone sets.

18. A method according to claim 14 further comprising the step of configuring an Instant Messaging (IM) key for a digital telephone set.

19. A method according to claim 18 further comprising the step of establishing the IM connection by pressing said instant messaging key.

20. A method according to claim 14 further comprising the step of sending a notification to said digital telephone set when a new instant message arrives.

21. A method according to claim 14 wherein said step of communicating is accomplished while the digital telephone set is off-hook.

22. A method according to claim 14 wherein said step of communicating includes composing and displaying instant messages using the standard key buttons and display space of said digital telephone set.

23. A method according to claim 14 wherein said step of communicating includes sending a notification to said digital telephone set when a request to add said digital telephone set client to the contact list of another instant messaging client is received.

24. A method according to claim 14 wherein said step of communicating includes using said digital telephone set to sign-in and sign-out for instant messaging services.

25. A method according to claim 14 wherein said step of communicating includes using said digital telephone set to change the on-line and off-line status of said digital telephone set for instant messaging.

26. A method according to claim 14 wherein said step of communicating includes using said digital telephone set to query the status of a contact list member.

27. A method according to claim 14 wherein said step of communicating includes determining the presence status of said digital telephone based on call activity of said digital telephone.

28. A method according to claim 14 wherein said step of communicating includes sending stored common replies to other instant messaging clients.

29. A method according to claim 28 wherein at least one of said stored common replies includes at least one custom data field.

30. A method according to claim 14 wherein said step of communicating includes sending stored common messages to other instant messaging clients.

31. A method according to claim 30 wherein at least one of said stored common messages includes at least one custom data field.

32. A method for performing instant messaging (IM) under a first protocol, said method comprising the steps of:
identifying a first device;
implementing a second protocol in a second device;
converting between said first protocol and said second protocol;
registering said first device and said second device; and
mapping a first client to said first device and a second client to said second device.

33. The method of claim 32 wherein said first protocol is a Session Initiation Protocol (SIP).

34. The method of claim 33 wherein said second protocol is a Computer Supported Telephony Application (CSTA).

35. The method of claim 34 wherein said first device is a first protocol device.

36. The method of claim 35 wherein said first device is a Personal Computer (PC).

37. The method of claim 34 wherein said second device is a digital telephone.

38. The method of claim 37 wherein said digital telephone is connected through a telephonic switch.

39. The method of claim 38 wherein said telephonic switch is a Private Branch Exchange (PBX).

40. The method of claim 34 wherein said first device is a second protocol device.

41. The method of claim 40 wherein said first device a digital telephone.

42. An apparatus for supporting Instant Messaging (IM) in digital telephones, comprising:
a register to register a first protocol digital telephone set;
a converter to convert said first protocol to a second protocol;
a map to map a client to said digital telephone set; and
a communication device to communicate an instant message to or from said digital telephone set.

43. The apparatus of claim 42 furthering comprising:
a register to register a second device; wherein said map further maps a second client to said second device and said communication device further communicates an instant message between said first digital telephone set and said second device.

44. The apparatus of claim 43 wherein said second device is a personal computer (PC); and wherein said map further maps a second client to said PC and said communication device further communicates an instant message between said first digital telephone set and said PC.

45. The apparatus of claim 43 wherein said second device is a first protocol digital telephone set; and wherein said converter also converts said first protocol device to said second protocol device, said map further maps a second client to said second digital telephone set and said communication device further communicates an instant message between said first and said second digital telephone sets.

46. An apparatus according to claim 42 further comprising an Instant Messaging (IM) key configured to initiate instant messaging in a digital telephone set.
